(19) United States
(12) Patent Application Publication
(10) Pub. No.: US 2026/0239152 A1
(43) Pub. Date: Aug. 13, 2026

(54) METHODS AND APPARATUSES OF AN MRO MECHANISM FOR A MOBILITY PROCEDURE

(71) Applicant: Lenovo (Beijing) Limited, Beijing (CN)

(72) Inventors: Le Yan, Shanghai (CN); Mingzeng Dai, Shanghai (CN); Congchi Zhang, Shanghai (CN); Lianhai Wu, Beijing (CN); Shuigen Yang, Shanghai (CN); Yibin Zhuo, Shanghai (CN)

(73) Assignee: Lenovo (Beijing) Limited, Beijing (CN)

(21) Appl. No.: 19/151,892

(22) PCT Filed: Apr. 3, 2023
(86) PCT No.: PCT/CN2023/085997

§ 371 Date: Jul. 29, 2025

(51) Int. Cl. H04W 36/36

(52) U.S. Cl. CPC H04W 36/362

(57) ABSTRACT

Embodiments of the present application relate to methods and apparatuses of a mobility robustness optimization (MRO) mechanism for a mobility procedure, for example, a MRO mechanism for a conditional handover (CHO) procedure, or a MRO mechanism for a conditional primary secondary cell group cell (PSCell) change/conditional PSCell addition (CPC/CPA) procedure, or a MRO mechanism for a CHO including target master cell group (MCG) and candidate secondary cell groups (SCG) s for CPC/CPA procedure. According to an embodiment of the present application, a network node includes a transceiver and a processor coupled to the transceiver, and the processor is configured to cause the network node to: obtain information of a cell for recovering a failure, when the failure occurs in one of the following: a CHO procedure, a conditional PSCell addition or change (CPAC) procedure, and a CHO including target MCG and candidate SCGs for CPC/CPA procedure; and perform analysis for the failure.

### TECHNICAL FIELD

Embodiments of the present application generally relate to methods and apparatuses of a mobility robustness optimization (MRO) mechanism for a mobility procedure, for example, a MRO mechanism for a conditional handover (CHO) procedure, or a MRO mechanism for a conditional primary secondary cell group cell (PSCell) change/conditional PSCell addition (CPC/CPA) procedure, or a MRO mechanism for a CHO including target master cell group (MCG) and candidate secondary cell groups (SCG)s for CPC/CPA procedure.

### BACKGROUND

In a multi-radio dual connectivity (MR-DC) scenario, a UE with multiple transceivers may be configured to utilize resources provided by two different nodes connected via non-ideal backhauls. Wherein one node may provide new radio (NR) access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface (for example, a Xn or X2 interface as specified in 3rd Generation Partnership Project (3GPP) standard documents), and at least the MN is connected to the core network.

Currently, a conditional PSCell addition (CPA) procedure and a conditional PSCell change (CPC) procedure are supported. A CPAC procedure may be a CPA procedure or a CPC procedure. According to agreements of 3GPP standard documents, a CPAC procedure is defined as a PSCell addition or a PSCell change that is executed by a UE when the configured CPAC execution condition(s) is met or fulfilled. A UE starts evaluating the CPAC execution condition(s) upon receiving CPAC related configuration information, and stops evaluating the CPAC execution condition(s) once a PSCell addition and/or change procedure is triggered or executed, the PSCell addition and/or change procedure is triggered or executed means that when CPAC execution condition(s) of a candidate PSCell is satisfied or fulfilled (“candidate PSCell” may also be named as “CPAC candidate PSCell”), the UE decides the candidate PSCell as a target PSCell, and performs a PSCell addition or change procedure with the target PSCell, e.g. the UE performs a RA procedure towards the target PSCell.

A CHO is defined as a handover that is executed by a user equipment (UE) when one or more CHO execution conditions are met. The UE starts evaluating the one or more CHO execution conditions upon receiving the CHO related configuration information (e.g. including one or more configurations associated with candidate PCell(s) and one or more CHO execution conditions), and stops evaluating the CHO execution conditions during the CHO execution or once the one or more CHO execution conditions are met or fulfilled. The CHO execution means that when CHO execution condition(s) of a candidate PCell is satisfied or fulfilled (“candidate PCell” may also be named as “CHO candidate PCell”), the UE decides the candidate PCell as a target PCell, and performs a PCell change or handover procedure with the target PCell, e.g. the UE performs a RA procedure towards the target PCell.

In a CHO including target MCG and candidate SCGs for CPC/CPA procedure, when a UE receives configuration(s) for the CHO including target MCG and candidate SCGs for CPC/CPA procedure (i.e. CHO configuration(s) referring to or including CPC or CPA configuration, or configuration(s) for a CHO with candidate SCGs procedure), e.g. when the UE receives configuration for CHO candidate (target) PCell(s), CHO execution condition(s), configuration for CPAC candidate (target) PSCell(s) and CPAC execution condition(s), the CHO evaluation and the CPC or CPA evaluation may be concurrent. For example, the UE starts evaluation of CHO execution condition(s) for candidate (target) PCells and CPAC execution condition(s) for candidate (target) PSCells at the same time (when receiving the configuration for a CHO with candidate SCGs procedure). The UE doesn't execute CPC or CPA unless CHO execution condition(s) of a CHO candidate PCell is fulfilled.

Currently, details regarding an MRO mechanism for a CHO including target MCG and candidate SCGs for CPC/CPA procedure (which may also be named as a CHO including target MCG and candidate SCGs for CPA/CPC procedure, or a CHO with candidate SCGs procedure, or a CHO including target MCG and candidate SCGs procedure, or a CHO including candidate target MCG and candidate target SCGs for CPC/CPA procedure, or a CHO including candidate target MCG and candidate target SCGs procedure, or the like) have not been discussed yet.

### SUMMARY

Some embodiments of the present application provide a network node. The network node includes a transceiver and a processor coupled to the transceiver; and the processor is configured to cause the network node to: obtain information of a cell for recovering a failure, when the failure occurs in one of the following: a conditional handover (CHO) procedure, a conditional primary secondary cell group cell (PSCell) addition or change (CPAC) procedure, and a CHO including target master cell group (MCG) and candidate secondary cell groups (SCG)s for conditional PSCell change/conditional PSCell addition (CPC/CPA) procedure; and perform analysis for the failure.

In some embodiments, the network node is a source master node (MN), the processor is configured to cause the source MN to perform at least one of the following: modifying a list of CPAC candidate PSCells; transmitting first information to at least one candidate SN to indicate that one or more CPAC candidate PSCells are wrongly selected; indicating one or more candidate MNs to transmit the first information to the at least one candidate SN; optimizing a set of CPAC execution conditions; or transmitting second information to the one or more candidate MNs to indicate that the set of CPAC execution conditions are configured improperly.

In some embodiments, the network node is a source master node (MN), the cell is a PSCell, if the PSCell is not included in a list of CPAC candidate PSCells suggested by the source MN, the processor is configured to cause the source MN to modify the list of CPAC candidate PSCells.

In some embodiments, the network node is a source master node (MN), the cell is a PSCell, if the PSCell is included in a first list of CPAC candidate PSCells suggested by the source MN but not included in a second list of CPAC candidate PSCells selected by a candidate SN, the processor is configured to cause the source MN to: transmit first information to the candidate SN to indicate that the second list of CPAC candidate PSCells selected by the candidate SN is not suitable; or indicate one or more candidate MNs to transmit the first information to the candidate SN.

In some embodiments, the network node is a source master node (MN), the cell is a PSCell, if the PSCell is included in a list of CPAC candidate PSCells selected by a candidate SN, the processor is configured to cause the source MN to: optimize a set of CPAC execution conditions for the list of CPAC candidate PSCells; or transmit second information to one or more candidate MNs to indicate that the set of CPAC execution conditions are configured improperly.

In some embodiments, the network node is a source master node (MN), the processor is configured to cause the source MN to perform at least one of the following: modifying a list of CHO candidate PCells; transmitting third information to at least one candidate MN to indicate that one or more CHO candidate PCells are wrongly selected; or optimizing a set of CHO execution conditions.

In some embodiments, the network node is a source master node (MN), the cell is a primary cell (PCell), if the PCell is not included in a list of CHO candidate PCells suggested by the source MN, the processor is configured to cause the source MN to modify the list of CHO candidate PCells.

In some embodiments, the network node is a source master node (MN), the cell is a primary cell (PCell), if the PCell is included in a first list of CHO candidate PCells suggested by the source MN but not included in a second list of CHO candidate PCells selected by a candidate MN, the processor is configured to cause the source MN to transmit third information to the candidate MN to indicate that the second list of CHO candidate PCells selected by the candidate MN is not suitable.

In some embodiments, the network node is a source master node (MN), the cell is a primary cell (PCell), if the PCell is included in a list of CHO candidate PCells selected by a candidate MN, the processor is configured to cause the source MN to optimize a set of CHO execution conditions for the list of CHO candidate PCells.

In some embodiments, the processor is configured to cause the source MN to: decide the information of the cell; transmit the information of the cell; or receive the information of the cell.

In some embodiments, the processor is configured to cause the source MN to: transmit failure related information associated with the failure; or receive the failure related information.

In some embodiments, the network node is a candidate master node (MN), the processor is configured to cause the candidate MN to perform at least one of the following: modifying a list of CPAC candidate PSCells; transmitting fourth information to at least one candidate SN to indicate that one or more CPAC candidate PSCells are wrongly selected; optimizing a set of CPAC execution conditions; or transmitting fifth information to a source MN to indicate that the set of CPAC execution conditions are configured improperly.

In some embodiments, the network node is a candidate master node (MN), the cell is a PSCell, if the PSCell is not included in a list of CPAC candidate PSCells suggested by the candidate MN, the processor is configured to cause the candidate MN to modify the list of CPAC candidate PSCells.

In some embodiments, the network node is a candidate master node (MN), the cell is a PSCell, if the PSCell is included in a first list of CPAC candidate PSCells suggested by the candidate MN but not included in a second list of CPAC candidate PSCells selected by a candidate SN, the processor is configured to cause the candidate MN to transmit fourth information to the candidate SN to indicate that the second list of CPAC candidate PSCells selected by the candidate SN is not suitable.

In some embodiments, the network node is a candidate master node (MN), the cell is a PSCell, if the PSCell is included in a list of CPAC candidate PSCells selected by a candidate SN, the processor is configured to cause the candidate MN to: optimize a set of CPAC execution conditions for the list of CPAC candidate PSCells; or transmit fifth information to the source MN to indicate that the set of CPAC execution conditions are configured improperly.

In some embodiments, the network node is a candidate master node (MN), the processor is configured to cause the candidate MN to perform at least one of the following: receiving sixth information from a source MN which indicates that at least one CHO candidate PCell is wrongly selected; or modifying one or more CHO candidate PCells selected by the candidate MN.

In some embodiments, the processor is configured to cause the candidate MN to: decide the information of the cell; transmit the information of the cell; or receive the information of the cell.

In some embodiments, the processor is configured to cause the candidate MN to receive failure related information associated with the failure.

In some embodiments, the network node is a source secondary node (SN), the processor is configured to cause the source SN to perform at least one of the following: modifying a list of CPAC candidate PSCells; transmitting seventh information to at least one candidate SN to indicate that one or more CPAC candidate PSCells are wrongly selected; indicating a source MN to transmit the seventh information to the at least one candidate SN; or optimizing a set of CPAC execution conditions.

In some embodiments, the network node is a source secondary node (SN), the cell is a PSCell, if the PSCell is not included in a list of CPAC candidate PSCells suggested by the source SN, the processor is configured to cause the source SN to modify the list of CPAC candidate PSCells.

In some embodiments, the network node is a source secondary node (SN), the cell is a PSCell, if the PSCell is included in a first list of CPAC candidate PSCells suggested by the source SN but not included in a second list of CPAC candidate PSCells selected by a candidate SN, the processor is configured to cause the source SN to: transmit seventh information to the candidate SN to indicate that the second list of CPAC candidate PSCells selected by the candidate SN is not suitable; or indicate a source MN to transmit the seventh information to the candidate SN.

In some embodiments, the network node is a source secondary node (SN), the cell is a PSCell, if the PSCell is included in a list of CPAC candidate PSCells selected by a candidate SN, the processor is configured to cause the source SN to optimize a set of CPAC execution conditions for the list of CPAC candidate PSCells.

In some embodiments, the processor is configured to cause the source SN to: decide the information of the cell; transmit the information of the cell; or receive the information of the cell.

In some embodiments, the processor is configured to cause the source SN to receive failure related information associated with the failure.

In some embodiments, the failure related information includes at least one of the following: a type of a first fulfilled execution condition; a type of a second fulfilled execution condition; information indicating whether a CPAC execution condition of a CPAC candidate PSCell is fulfilled; information indicating whether a CHO execution condition of a CHO candidate PCell is fulfilled; information indicating whether a CPAC-execution-condition-fulfilled candidate PSCell is associated with a CHO-execution-condition-fulfilled candidate PCell; information indicating whether a leaving condition of the CHO-execution-condition-fulfilled candidate PCell is fulfilled, e.g. when the CPAC execution condition of a CPAC candidate PSCell is fulfilled; information indicating whether a leaving condition of the CPAC-execution-condition-fulfilled candidate PSCell is fulfilled, e.g. when the CHO execution condition of a CHO candidate PCell is fulfilled; time elapsed since the CHO execution condition is fulfilled until the CPAC execution condition is fulfilled; or time elapsed since the CPAC execution condition is fulfilled until the CHO execution condition is fulfilled.

In some embodiments, the failure is one of the following: an SCG failure, an MCG failure, a radio link failure (RLF), a CHO execution failure, and a CPAC execution failure.

In some embodiments, the failure occurs in a case in which configuration information related to the CHO including target MCG and candidate SCGs for CPC/CPA procedure is configured to a user equipment (UE), but neither a CHO execution nor a CPA/CPC execution is initiated for the UE prior to the failure.

In some embodiments, the failure is defined as too late CHO including target MCG and candidate SCGs for CPC/CPA.

In some embodiments, the case is one of the following: a CHO execution condition of a CHO candidate primary cell (PCell) is fulfilled, but a CPA/CPC execution condition of none CPAC candidate PSCell is fulfilled; the CHO execution condition of the CHO candidate PCell is firstly fulfilled, and a CPA/CPC execution condition of a CPAC candidate PSCell is secondly fulfilled, but the CPAC candidate PSCell is not associated with the CHO candidate PCell; the CHO execution condition of the CHO candidate PCell is firstly fulfilled, and a leaving condition of the CHO candidate PCell is satisfied when the CPA/CPC execution condition of the CPAC candidate PSCell is secondly fulfilled; the CPAC execution condition of the CPAC candidate PSCell is fulfilled, but a CHO execution condition of none CHO candidate PCell is fulfilled; the CPAC execution condition of the CPAC candidate PSCell is firstly fulfilled, and the CHO execution condition of the CHO candidate PCell is secondly fulfilled, but the CHO candidate PCell is not associated with the CPAC candidate PSCell; the CPAC execution condition of the CPAC candidate PSCell is firstly fulfilled, and a leaving condition of the CPAC candidate PSCell is satisfied when the CHO execution condition of the CHO candidate PCell is secondly fulfilled; and none CHO execution condition is fulfilled, and none CPAC execution condition is fulfilled.

In some embodiments, the failure occurs in one case of the following: a CPAC execution fails or an SCG failure occurs shortly after successful completion of the CPAC execution; a CHO execution fails or an MCG failure occurs shortly after successful completion of the CHO execution; and the CHO execution fails or the MCG failure occurs shortly after successful completion of the CHO execution, and the CPAC execution fails or the SCG failure occurs shortly after successful completion of the CPAC execution.

Some embodiments of the present application provide a candidate secondary node (SN). The candidate SN includes a transceiver and a processor coupled to the transceiver; and the processor is configured to cause the candidate SN to perform at least one of the following: receiving information which indicates that one or more conditional primary secondary cell group cell (PSCell) addition or change (CPAC) candidate PSCells are selected wrongly, wherein the information is received from a source master node (MN), a candidate MN, or a source SN; or modifying the one or more CPAC candidate PSCells.

In some embodiments, the information is received in case that a failure occurs in one of the following: a CPAC procedure; and a CHO including target master cell group (MCG) and candidate SCGs for conditional PSCell change/conditional PSCell addition (CPC/CPA) procedure.

In some embodiments, the failure is one of the following: a secondary cell group (SCG) failure, a radio link failure (RLF), and a CPAC execution failure.

In some embodiments, the failure occurs in a case in which configuration information related to the CHO including target MCG and candidate SCGs for CPC/CPA procedure is configured to a user equipment (UE), but neither a CHO execution nor a CPA/CPC execution is initiated for the UE prior to the failure.

In some embodiments, the failure is defined as too late CHO including target MCG and candidate SCGs for CPC/CPA.

In some embodiments, the case is one of the following: a CHO execution condition of a CHO candidate primary cell (PCell) is fulfilled, but a CPA/CPC execution condition of none CPAC candidate PSCell is fulfilled; the CHO execution condition of the CHO candidate PCell is firstly fulfilled, and a CPA/CPC execution condition of a CPAC candidate PSCell is secondly fulfilled, but the CPAC candidate PSCell is not associated with the CHO candidate PCell; the CHO execution condition of the CHO candidate PCell is firstly fulfilled, and a leaving condition of the CHO candidate PCell is satisfied when the CPA/CPC execution condition of the CPAC candidate PSCell is secondly fulfilled; the CPAC execution condition of the CPAC candidate PSCell is fulfilled, but a CHO execution condition of none CHO candidate PCell is fulfilled; the CPAC execution condition of the CPAC candidate PSCell is firstly fulfilled, and the CHO execution condition of the CHO candidate PCell is secondly fulfilled, but the CHO candidate PCell is not associated with the CPAC candidate PSCell; the CPAC execution condition of the CPAC candidate PSCell is firstly fulfilled, and a leaving condition of the CPAC candidate PSCell is satisfied when the CHO execution condition of the CHO candidate PCell is secondly fulfilled; and none CHO execution condition is fulfilled, and none CPAC execution condition is fulfilled.

In some embodiments, the failure occurs in one case of the following: a CPAC execution fails or an SCG failure occurs shortly after successful completion of the CPAC execution; a CHO execution fails or an MCG failure occurs shortly after successful completion of the CHO execution; and the CHO execution fails or the MCG failure occurs shortly after successful completion of the CHO execution, and the CPAC execution fails or the SCG failure occurs shortly after successful completion of the CPAC execution.

Some embodiments of the present application provide a user equipment (UE). The UE includes a transceiver and a processor coupled to the transceiver; and the processor is configured to cause the UE to: store failure related information associated with a failure, wherein the failure occurs in a conditional handover (CHO) including target master cell group (MCG) and candidate secondary cell groups (SCGs) for conditional primary secondary cell group cell (PSCell) change/conditional PSCell addition (CPC/CPA) procedure; and transmit the failure related information.

In some embodiments, the failure related information includes at least one of the following: a type of a first fulfilled execution condition; a type of a second fulfilled execution condition; information indicating whether a conditional PSCell addition or change (CPAC) execution condition of a CPAC candidate PSCell is fulfilled; information indicating whether a CHO execution condition of a CHO candidate PCell is fulfilled; information indicating whether a CPAC-execution-condition-fulfilled candidate PSCell is associated with a CHO-execution-condition-fulfilled candidate primary cell (PCell); information indicating whether a leaving condition of the CHO-execution-condition-fulfilled candidate PCell is fulfilled, e.g. when the CPAC execution condition of a CPAC candidate PSCell is fulfilled; information indicating whether a leaving condition of the CPAC-execution-condition-fulfilled candidate PSCell is fulfilled, e.g. when the CHO execution condition of a CHO candidate PCell is fulfilled; time elapsed since the CHO execution condition is fulfilled until the CPAC execution condition is fulfilled; or time elapsed since the CPAC execution condition is fulfilled until the CHO execution condition is fulfilled.

In some embodiments, the failure is one of the following: an MCG failure; an SCG failure; a radio link failure (RLF); a CHO execution failure; and a conditional PSCell addition or change (CPAC) execution failure.

In some embodiments, the processor is configured to cause the UE to receive configuration information related to the CHO including target MCG and candidate SCGs for CPC/CPA procedure, and wherein the failure occurs in a case in which the configuration information is received but neither a CHO execution nor a CPA/CPC execution is initiated for the UE prior to the failure.

In some embodiments, the failure is defined as too late CHO including target MCG and candidate SCGs for CPC/CPA.

In some embodiments, the case is one of the following: a CHO execution condition of a CHO candidate PCell is fulfilled, but a CPA/CPC execution condition of none conditional PSCell addition or change (CPAC) candidate PSCell is fulfilled; the CHO execution condition of the CHO candidate PCell is firstly fulfilled, and a CPA/CPC execution condition of a CPAC candidate PSCell is secondly fulfilled, but the CPAC candidate PSCell is not associated with the CHO candidate PCell; the CHO execution condition of the CHO candidate PCell is firstly fulfilled, and a leaving condition of the CHO candidate PCell is satisfied when the CPA/CPC execution condition of the CPAC candidate PSCell is secondly fulfilled; the CPAC execution condition of the CPAC candidate PSCell is fulfilled, but a CHO execution condition of none CHO candidate PCell is fulfilled; the CPAC execution condition of the CPAC candidate PSCell is firstly fulfilled, and the CHO execution condition of the CHO candidate PCell is secondly fulfilled, but the CHO candidate PCell is not associated with the CPAC candidate PSCell; the CPAC execution condition of the CPAC candidate PSCell is firstly fulfilled, and a leaving condition of the CPAC candidate PSCell is satisfied when the CHO execution condition of the CHO candidate PCell is secondly fulfilled; and none CHO execution condition is fulfilled, and none CPAC execution condition is fulfilled.

In some embodiments, the failure occurs in one case of the following: a CPAC execution fails or an SCG failure occurs shortly after successful completion of the CPAC execution; a CHO execution fails or an MCG failure occurs shortly after successful completion of the CHO execution; and the CHO execution fails or the MCG failure occurs shortly after successful completion of the CHO execution, and the CPAC execution fails or the SCG failure occurs shortly after successful completion of the CPAC execution.

Some embodiments of the present application provide a method performed by a network node. The method includes: obtaining information of a cell for recovering a failure, when the failure occurs in one of the following: a conditional handover (CHO) procedure, a conditional primary secondary cell group cell (PSCell) addition or change (CPAC) procedure, and a CHO including target master cell group (MCG) and candidate secondary cell groups (SCG)s for conditional PSCell change/conditional PSCell addition (CPC/CPA) procedure; and performing analysis for the failure.

Some embodiments of the present application provide a method performed by a candidate secondary node (SN). The method includes performing at least one of the following: receiving information which indicates that one or more conditional primary secondary cell group cell (PSCell) addition or change (CPAC) candidate PSCells are selected wrongly, wherein the information is received from a source master node (MN), a candidate MN, or a source SN; or modifying the one or more CPAC candidate PSCells.

Some embodiments of the present application provide a method performed by a UE. The method includes: storing failure related information associated with a failure, wherein the failure occurs in a conditional handover (CHO) including target master cell group (MCG) and candidate secondary cell groups (SCG)s for conditional primary secondary cell group cell (PSCell) change/conditional PSCell addition (CPC/CPA) procedure; and transmitting the failure related information.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a UE or a network node (a source MN, a candidate MN, a source SN, or a candidate SN).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary procedure of performing failure analysis in accordance with some embodiments of the present application.

FIG. 3 illustrates an exemplary procedure performed by a candidate SN in accordance with some embodiments of the present application.

FIG. 4 illustrates an exemplary procedure performed by a UE in accordance with some embodiments of the present application.

FIG. 5 illustrates a block diagram of an exemplary apparatus in accordance with some embodiments of the present disclosure.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates a schematic diagram of a wireless communication system in accordance with some embodiments of the present application.

As shown in FIG. 1, the wireless communication system 100 may be a dual connectivity system 100, including at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, UE 101 may be connected to MN 102 and SN 103 via a network interface, for example, the Uu interface as specified in 3GPP standard documents. MN 102 and SN 103 may be connected with each other via a network interface, for example, the Xn interface as specified in 3GPP standard documents for NR-NR DC or NGEN-DC or NE-DC, or X2 interface as specified in 3GPP standard documents for EN-DC. MN 102 may be connected to the core network via a network interface (not shown in FIG. 1). UE 102 may be configured to utilize resources provided by MN 102 and SN 103 to perform data transmission.

MN 102 may refer to a radio access node that provides a control plane connection to the core network. In an embodiment of the present application, in the E-UTRA-NR Dual Connectivity (EN-DC) scenario, MN 102 may be an eNB. In another embodiment of the present application, in the next generation E-UTRA-NR Dual Connectivity (NGEN-DC) scenario, MN 102 may be an ng-eNB. In yet another embodiment of the present application, in the NR-E-UTRA Dual Connectivity (NE-DC) scenario or the NR-NR Dual Connectivity (NR-DC) scenario, MN 102 may be a gNB.

MN 102 may be associated with a master cell group (MCG). The MCG may refer to a group of serving cells associated with MN 102, and may include a primary cell (PCell) and optionally one or more secondary cells (SCells) of the MCG. The PCell may provide a control plane connection to UE 101.

SN 103 may refer to a radio access node without a control plane connection to the core network but providing additional resources to UE 101. In an embodiment of the present application, in the EN-DC scenario, SN 103 may be an en-gNB. In another embodiment of the present application, in the NE-DC scenario, SN 103 may be a ng-eNB. In yet another embodiment of the present application, in the NR-DC scenario or the NGEN-DC scenario, SN 103 may be a gNB.

SN 103 may be associated with a secondary cell group (SCG). The SCG may refer to a group of serving cells associated with SN 103, and may include a primary secondary cell (PSCell) and optionally one or more secondary cells (SCells). The PCell of the MCG and the PSCell of the SCG may also be referred to as a special cell (SpCell).

In some embodiments of the present application, UE 101 may include computing devices, such as desktop computers, laptop computers, personal digital assistants (PDAs), tablet computers, smart televisions (e.g. televisions connected to the Internet), set-top boxes, game consoles, security systems (including security cameras), vehicle on-board computers, network devices (e.g. routers, switches, and modems), or the like. In some other embodiments of the present application, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 may include wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In general, a CHO is executed by a UE when at least one CHO execution condition is met or satisfied or fulfilled. For example, when one or two CHO execution condition(s) of a candidate PCell is satisfied or fulfilled, a CHO execution is performed, “a CHO execution” may be an operation that the UE decides the CHO-execution-condition-fulfilled candidate PCell as a target PCell, and performs a PCell change or handover with the target PCell, e.g. the UE performs a RA procedure towards the target PCell. A UE starts evaluating the CHO execution condition(s) upon receiving the CHO configuration, and stops CHO execution condition evaluating once the at least one CHO execution condition is met or fulfilled. CHO configuration contains the configuration for CHO candidate PCell(s) generated by the candidate BS(s) (e.g. candidate (target) MN(s)) and CHO execution condition(s) generated by the source BS (e.g. source MN).

A CPAC is executed by a UE when one or more CPAC execution conditions are met or satisfied or fulfilled. For example, when at least one CPAC execution condition of a candidate PSCell is satisfied or fulfilled, a CPAC execution is performed, “a CPAC execution” may be an operation that the UE decides the CPAC-execution-condition-fulfilled candidate PSCell as a target PSCell, and performs a PSCell addition or change with the target PSCell, e.g. the UE performs a RA procedure towards the target PSCell. A UE starts evaluating the CPAC execution condition(s) upon receiving the CPAC configuration, and stops evaluating the CPAC execution condition(s) once the at least one CPAC execution condition is met or fulfilled. CPAC configuration (i.e. CPA or CPC configuration) contains the configuration for CPAC candidate PSCell(s) generated by the candidate (target) SN(s) and CPAC execution condition(s) generated by the source SN or source MN.

One objective for mobility enhancements in 3GPP Rel-18 is to specify a CHO including target MCG and candidate SCGs for CPC/CPA procedure. A CHO including target MCG and candidate SCGs for CPC/CPA procedure may also be named as “a CHO including candidate (target) MCG and candidate (target) SCGs for CPC/CPA procedure,” “a CHO including target MCG and candidate SCGs for CPA procedure, or a CHO including target MCG and candidate SCGs for CPC procedure”, “a CHO with candidate SCGs procedure,” or the like. For instance, below scenarios can be considered for a CHO including target MCG and candidate SCGs for CPC/CPA procedure:
(1) Scenario 1 “CHO with CPA”: CHO from single-connectivity to a MR-DC connection, e.g. CHO from source PCell 1 to candidate (target) PCell 2 with candidate (target) SN(s). That is, in Scenario 1, single-connectivity is changed to dual-connectivity.
(2) Scenario 2 “CHO with intra-SN CPC”: for example, CHO from source PCell 1 with SCG 1 in SN 1 to candidate (target) PCell 2 with candidate (target) SCG(s) in the same SN 1. That is, in Scenario 2, PCell is changed, PSCell is changed but SN is not changed.
(3) Scenario 3 “CHO with inter-SN CPC”: CHO from source PCell 1 (e.g. managed by S-MN) with SN 1 (e.g. S-SN) to candidate (target) PCell 2 (e.g. managed by T-MN) with candidate (target) SN(s) other than SN1 (e.g. T-SN). That is, in Scenario 3, PCell is changed, and SN is changed.

CHO configuration referring to or including CPC or CPA configuration (intended to be applicable together) can be supported in a CHO including target MCG and candidate SCGs for CPC/CPA procedure. In a CHO including target MCG and candidate SCGs for CPC/CPA procedure, one or more CHO candidate PCells can be configured, wherein for one CHO candidate PCell, one or two CHO execution conditions can be configured; for one CHO candidate PCell, one or more associated CPAC candidate PSCells can be configured; and for one CPAC candidate PSCell, one or two CPAC execution conditions can be configured.

In a CHO including target MCG and candidate SCGs for CPC/CPA procedure, CHO execution condition evaluation and CPC/CPA execution condition evaluation can be concurrent or simultaneous. For example, the UE starts evaluation of execution condition(s) for CHO candidate PCells and execution condition(s) for CPAC candidate PSCells at the same time (e.g. when receiving the configuration for the CHO with candidate SCGs procedure).

When the UE receives configuration(s) for a CHO including target MCG and candidate SCGs for CPC/CPA procedure (i.e. CHO configuration(s) referring to or including CPC or CPA configuration, or configuration(s) for a CHO with candidate SCGs procedure), e.g. when the UE receives configuration for CHO candidate (target) PCell(s), CHO execution condition(s), configuration for CPAC candidate (target) PSCell(s) and CPAC execution condition(s), the CHO evaluation and the CPC or CPA evaluation may be concurrent. For example, the UE starts evaluation of CHO execution condition(s) for candidate (target) PCells and CPAC execution condition(s) for candidate (target) PSCells at the same time (when receiving the configuration for a CHO with candidate SCGs procedure). The UE doesn't execute CPC or CPA unless CHO execution condition(s) of a CHO candidate PCell is fulfilled. The UE does not need to unpack any of the nested conditional configuration containers in order to measure.

In a CHO including target MCG and candidate SCGs for CPC/CPA procedure, a UE evaluates whether CHO execution condition(s) and/or CPC/CPA execution condition(s) is fulfilled, in the case that anyone of CHO execution condition(s) and CPC/CPA execution condition(s) is not fulfilled, or in the case that anyone of CHO execution and CPC/CPA execution fails, an MCG failure and/or an SCG failure would happen.

Currently, in above scenarios, several issues need to be addressed. To improve mobility robustness, an MRO mechanism for a CHO including target MCG and candidate SCGs for CPC/CPA procedure should be considered, including, for example, what information from a UE is needed for a network node to perform MRO for modifying configurations of the CHO including target MCG and candidate SCGs for CPC/CPA procedure, and how a network node performs root cause analysis for MRO purpose.

Embodiments of the present disclosure aim to solve such issues in the abovementioned scenarios. For instance, some embodiments define “too late CHO with candidate SCGs procedure” or define “too late CHO with CPA/CPC execution”. In some embodiments, to enable MRO analysis for a CHO including target MCG and candidate SCGs for CPC/CPA procedure, a UE needs to store and report failure related information. Some embodiments provide a method for network MRO analysis in case that an MCG failure or an RLF or a CHO execution failure occurs. Some embodiments provide a method for network MRO analysis in case that an SCG failure or an RLF or a CPAC execution failure occurs. More details regarding the embodiments of the present application will be illustrated in the following text in combination with the appended drawings.

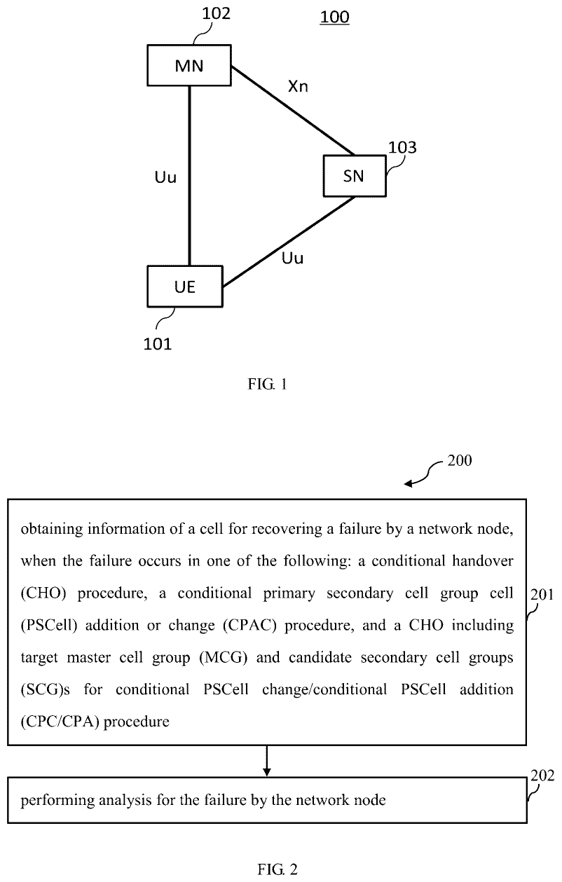

FIG. 2 illustrates an exemplary procedure of performing failure analysis in accordance with some embodiments of the present application. The exemplary procedure 200 in the embodiments of FIG. 2 may be performed by a network node, for example, a source MN (S-MN), a candidate (target) MN, or a source SN (S-SN), e.g. MN 102 or SN 103 as shown in FIG. 1. Although described with respect to a network node, it should be understood that other devices may be configured to perform a method similar to that of FIG. 2.

In the exemplary procedure 200 as shown in FIG. 2, in operation 201, a network node may obtain information of a cell for recovering a failure, when the failure occurs in one of the following: a CHO procedure, a CPAC procedure, and a CHO including target MCG and candidate SCGs for CPC/CPA procedure. In operation 202, the network node may perform analysis for the failure.

In some embodiments, the network node is a source MN (a node which manages the source PCell), and the source MN may perform at least one of the following operations, for example, in case that an SCG failure or an RLF or a CPAC execution failure occurs:
(1) Modifying a list of CPAC candidate PSCells.
(2) Transmitting information to at least one candidate SN to indicate that one or more CPAC candidate PSCells are wrongly selected. For one example, the source MN may transmit one message to one or more candidate SNs separately to indicate that one or more CPAC candidate PSCells are wrongly selected. The message may be an existing Xn or X2 message, or a new introduced Xn or X2 message. For another example, the source MN may transmit one indication to one or more candidate SNs separately to indicate that one or more CPAC candidate PSCells are wrongly selected. The indication may be included in an existing Xn or X2 message, or in a new introduced Xn or X2 message.
(3) Indicating one or more candidate MNs to transmit information to the at least one candidate SN to indicate that one or more CPAC candidate PSCells are wrongly selected. For instance, in an embodiment, the source MN may firstly transmit a message X to the one or more candidate MNs separately (optionally, ID information of the one or more candidate SNs may be included in the message X; and the message X may be an existing Xn or X2 message, or a new introduced Xn or X2 message), and then, the one or more candidate MNs may transmit a message Y to the corresponding candidate SN separately to indicate that one or more CPAC candidate PSCells are wrongly selected (the message Y may be an existing Xn or X2 message, or a new introduced Xn or X2 message). For another instance, the source MN may transmit indication P to one or more candidate MNs separately to indicate the candidate MN to inform one or more candidate SNs that one or more CPAC candidate PSCells are wrongly selected, and then, the one or more candidate MNs may transmit indication Q to one or more candidate SNs separately to indicate that one or more CPAC candidate PSCells are wrongly selected (the indication P or Q may be included in an existing Xn or X2 message, or in a new introduced Xn or X2 message).
(4) Optimizing a set of CPAC execution conditions.
(5) Transmitting information to the one or more candidate MNs to indicate that the set of CPAC execution conditions are configured improperly.

In an embodiment, the cell is a PSCell for recovering the failure, and if the PSCell is not included in a list of CPAC candidate PSCells suggested or provided by the source MN, the source MN may modify the list of CPAC candidate PSCells.

In an embodiment, the cell is a PSCell for recovering the failure, and if the PSCell is included in a list of CPAC candidate PSCells suggested or provided by the source MN but not included in another list of CPAC candidate PSCells selected or prepared by a candidate SN:
(1) the source MN may transmit information to the candidate SN to indicate that the another list of CPAC candidate PSCells selected or provided by the candidate SN is not suitable; for example, this information may be a message or may be indicating information included in a message; for instance, the source MN may transmit such information to one or more candidate SNs separately; or
(2) the source MN may indicate one or more candidate MNs to transmit the information, which indicate that the another list of CPAC candidate PSCells selected or prepared by the candidate SN is not suitable, to the candidate SN. For example, the source MN may firstly transmit a message to the one or more candidate MNs separately to inform them to indicate one or more candidate SNs that one or more CPAC candidate PSCells are wrongly selected (optionally, ID information of the one or more candidate SNs may be included in the message; and the message may be an existing Xn or X2 message, or a new introduced Xn or X2 message), and then, the one or more candidate MNs may transmit a message to the corresponding candidate SN separately to indicate that one or more CPAC candidate PSCells are wrongly selected (the message may be an existing Xn or X2 message, or a new introduced Xn or X2 message). For another instance, the source MN may transmit an indication to one or more candidate MNs separately to indicate the candidate MN to inform one or more candidate SNs that one or more CPAC candidate PSCells are wrongly selected, and then, the one or more candidate MNs may transmit an indication to one or more candidate SNs separately to indicate that one or more CPAC candidate PSCells are wrongly selected (the indication may be included in an existing Xn or X2 message, or in a new introduced Xn or X2 message).

In an embodiment, the cell is a PSCell for recovering the failure, and if the PSCell is included in a list of CPAC candidate PSCells selected or prepared by a candidate SN, the source MN may optimize a set of CPAC execution conditions for the list of CPAC candidate PSCells, or the source MN may transmit information to one or more candidate MNs to indicate that the set of CPAC execution conditions are configured improperly.

In some embodiments, the network node is a source MN, and the source MN may perform at least one of the following operations, for example, in case that an MCG failure or an RLF or a CHO execution failure occurs:
(1) modifying a list of CHO candidate PCells;
(2) transmitting information to at least one candidate MN to indicate that one or more CHO candidate PCells are wrongly selected, for one example, the source MN may transmit one message to one or more candidate MNs separately to indicate that one or more CHO candidate PCells are wrongly selected; and the message may be an existing Xn or X2 message, or a new introduced Xn or X2 message. For another example, the source MN may transmit one indication to one or more candidate MNs separately to indicate that one or more CHO candidate PCells are wrongly selected; and the indication may be included in an existing Xn or X2 message, or in a new introduced Xn or X2 message; or
(3) optimizing a set of CHO execution conditions.

In an embodiment, the cell is a PCell for failure recovery, and if the PCell is not included in a list of CHO candidate PCells suggested or provided by the source MN, the source MN may modify the list of CHO candidate PCells.

In an embodiment, the cell is a PCell for failure recovery, and if the PCell is included in a list of CHO candidate PCells suggested or provided by the source MN but not included in another list of CHO candidate PCells selected or prepared by a candidate MN, the source MN may transmit information to the candidate MN to indicate that the another list of CHO candidate PSCells selected or prepared by the candidate MN is not suitable. For example, this information may be a message or may be indicating information included in a message. For instance, the source MN may transmit such information to one or more candidate MNs separately.

In an embodiment, the cell is a PCell for failure recovery, and if the PCell is included in a list of CHO candidate PCells selected or prepared by a candidate MN, the source MN may optimize a set of CHO execution conditions for the list of CHO candidate PCells.

In some embodiments, the source MN may decide the information of the cell, transmit the information of the cell, or receive the information of the cell. In an embodiment, if the cell is a PCell for failure recovery, or if the cell is a P SCell for recovering the failure, the source MN may obtain the information of the cell by deciding the information of the cell, e.g. in operation 201. Optionally, after deciding the information of the cell, the source MN may transmit the information of the cell, e.g. to one or more candidate MNs. In another embodiment, if the information of the cell is decided by other node (e.g. one or more candidate MNs, or a source SN), the source MN may receive the information of the cell from the other node (e.g. one or more candidate MNs, or the source SN), to obtain the information of the cell, e.g. in operation 201.

In some embodiments, the source MN may transmit failure related information (denoted as failure related information #1 for simplicity) associated with the failure, e.g. to the one or more candidate MNs or to the source SN. In some other embodiments, the source MN may receive failure related information associated with the failure, e.g. from a source SN or at least one candidate MN or a receiving network node (e.g. a third party node different from the source MN or the source SN), the failure related information may be stored or generated or sent by a UE.

In an embodiment, failure related information (e.g. failure related information #1) may include at least one of the following:
(1) a type of a first fulfilled or triggered execution condition or conditional event; for example, the type may be CHO execution condition/CHO conditional event or CPAC execution condition/CPAC conditional event;
(2) a type of a second fulfilled or triggered execution condition or conditional event; for example, the type may be CHO execution condition/CHO conditional event or CPAC execution condition/CPAC conditional event;
(3) information indicating whether one or two CPAC execution conditions of a CPAC candidate PSCell is fulfilled or triggered, e.g. if one or two CHO execution conditions of a CHO candidate PCell is firstly fulfilled or triggered;
(4) information indicating whether one or two CHO execution conditions of a CHO candidate PCell is fulfilled or triggered, e.g. if one or two CPAC execution conditions of a CPAC candidate PSCell is firstly fulfilled or triggered;
(5) cell information of source PCell, e.g. the cell information may include PCI, carrier frequency information (e.g. ARFCN), and/or, CGI-info (e.g. PLMN-Identity, Cell Identity and TrackingAreaCode);
(6) cell information of failed PCell;
(7) cell information of source PSCell;
(8) cell information of failed PSCell.

In an embodiment, if both the CHO execution condition(s) and the CPAC execution condition(s) are fulfilled, failure related information #1 may include at least one of the following:
(1) information indicating whether a CPAC-execution-condition-fulfilled candidate PSCell (i.e. a CPAC candidate PSCell whose CPAC execution condition(s) has been fulfilled or triggered) is associated with a CHO-execution-condition-fulfilled candidate PCell (i.e. a CHO candidate PCell whose CHO execution condition(s) has been fulfilled or triggered);
(2) information indicating whether a leaving condition of the CHO-execution-condition-fulfilled candidate PCell is fulfilled, e.g. when the one or two CPAC execution conditions of a CPAC candidate PSCell is fulfilled or triggered;
(3) information indicating whether a leaving condition of the CPAC-execution-condition-fulfilled candidate PSCell is fulfilled, e.g. when the one or two CHO execution conditions of a CHO candidate PCell is fulfilled or triggered;
(4) time elapsed since the one or two CHO execution conditions of a CHO candidate PCell is fulfilled or triggered until the one or two CPAC execution conditions of a CPAC candidate PSCell is fulfilled or triggered; or
(5) time elapsed since the one or two CPAC execution conditions of a CPAC candidate PSCell is fulfilled or triggered until the one or two CHO execution conditions of a CHO candidate PCell is fulfilled or triggered.

In some embodiments, the network node is a candidate MN (a node which manages one or more CHO candidate PCells), and the candidate MN may perform at least one of the following operations, for example, in case that an SCG failure or an RLF or a CPAC execution failure occurs:
(1) modifying a list of CPAC candidate PSCells;
(2) transmitting information to at least one candidate SN to indicate that one or more CPAC candidate PSCells are wrongly selected, for one example, the candidate MN may transmit one message to one or more candidate SNs separately to indicate that one or more CPAC candidate PSCells are wrongly selected. The message may be an existing Xn or X2 message, or a new introduced Xn or X2 message. For another example, the source MN may transmit one indication to one or more candidate SNs separately to indicate that one or more CPAC candidate PSCells are wrongly selected. The indication may be included in an existing Xn or X2 message, or in a new introduced Xn or X2 message;
(3) optimizing a set of CPAC execution conditions; or
(4) transmitting information to a source MN to indicate that the set of CPAC execution conditions are configured improperly.

In an embodiment, the cell is a PSCell for recovering the failure, and if the PSCell is not included in a list of CPAC candidate PSCells suggested or provided by the candidate MN, the candidate MN may modify the list of CPAC candidate PSCells.

In an embodiment, the cell is a PSCell for recovering the failure, and if the PSCell is included in a list of CPAC candidate PSCells suggested or provided by the candidate MN but not included in another list of CPAC candidate PSCells selected or prepared by a candidate SN, the candidate MN may transmit information to the candidate SN to indicate that the another list of CPAC candidate PSCells selected or prepared by the candidate SN is not suitable. For instance, this information may be a message or may be indicating information included in a message, and the candidate MN may transmit such information to one or more candidate SNs separately.

In an embodiment, the cell is a PSCell for recovering the failure, and if the PSCell is included in a list of CPAC candidate PSCells selected or prepared by a candidate SN, the candidate MN may optimize a set of CPAC execution conditions for the list of CPAC candidate PSCells, or the candidate MN may transmit information to the source MN to indicate that the set of CPAC execution conditions are configured improperly.

In an embodiment, the candidate MN may perform at least one of the following operations, for example, in case that an MCG failure or an RLF or a CHO execution failure occurs:
(1) receiving information from a source MN which indicates that at least one CHO candidate PCell is wrongly selected, for one example, the candidate MN may receive one message from the source MN which indicates that one or more CHO candidate PCells are wrongly selected. The message may be an existing Xn or X2 message, or a new introduced Xn or X2 message. For another example, candidate MN may receive one indication from the source MN which indicates that one or more CHO candidate PCells are wrongly selected. The indication may be included in an existing Xn or X2 message, or in a new introduced Xn or X2 message; or
(2) modifying one or more CHO candidate PCells selected or prepared by the candidate MN.

In some embodiments, the candidate MN may decide the information of the cell, transmit the information of the cell, or receive the information of the cell. In an embodiment, the candidate MN may obtain the information of the cell by deciding the information of the cell, e.g. in operation 201. Optionally, after deciding the information of the cell, the candidate MN may transmit the information of the cell to the source MN. In another embodiment, if the information of the cell is decided by other node (e.g. the source MN, or source SN), the candidate MN may receive the information of the cell from the other node (e.g. source MN, or source SN), to obtain the information of the cell, e.g. in operation 201.

In some embodiments, the candidate MN may receive failure related information associated with the failure, e.g. failure related information #1 as described above, from the source MN. In some other embodiments, the candidate MN may receive failure related information associated with the failure, e.g. failure related information #1 as described above, from one or more candidate SN.

In some embodiments, the network node is a source SN (a node which manages the source PSCell), and the source SN may perform at least one of the following operations, for example, in case that an SCG failure or an RLF or a CPAC execution failure occurs:
(1) modifying a list of CPAC candidate PSCells;
(2) transmitting information to at least one candidate SN to indicate that one or more CPAC candidate PSCells are wrongly selected; for one example, the source SN may transmit one message to one or more candidate SNs separately to indicate that one or more CPAC candidate PSCells are wrongly selected. The message may be an existing Xn or X2 message, or a new introduced Xn or X2 message. For another example, the source SN may transmit one indication to one or more candidate SNs separately to indicate that one or more CPAC candidate PSCells are wrongly selected. The indication may be included in an existing Xn or X2message, or in a new introduced Xn or X2 message;
(3) indicating a source MN to transmit the information, which indicates that one or more CPAC candidate PSCells are wrongly selected, to the at least one candidate SN. For example, the source SN may firstly transmit a message to the source MN to inform the source MN to indicate one or more candidate SNs that one or more CPAC candidate PSCells are wrongly selected (optionally, ID information of the one or more candidate SNs may be included in the message; and the message may be an existing Xn or X2 message, or a new introduced Xn or X2 message), and then, the source MN may transmit a message to the corresponding candidate SN separately to indicate that one or more CPAC candidate PSCells are wrongly selected (the message may be an existing Xn or X2 message, or a new introduced Xn or X2 message). For another instance, the source SN may transmit an indication to the source MN to indicate the source MN to inform one or more candidate SNs that one or more CPAC candidate PSCells are wrongly selected, and then, the source MN may transmit an indication to one or more candidate SNs separately to indicate that one or more CPAC candidate PSCells are wrongly selected (the indication may be included in an existing Xn or X2 message, or in a new introduced Xn or X2 message); or
(4) optimizing a set of CPAC execution conditions.

In an embodiment, the cell is a PSCell for recovering the failure, and if the PSCell is not included in a list of CPAC candidate PSCells suggested or provided by the source SN, the source SN may modify the list of CPAC candidate PSCells.

In some embodiments, the cell is a PSCell for recovering the failure, and if the PSCell is included in a list of CPAC candidate PSCells suggested or provided by the source SN but not included in another list of CPAC candidate PSCells selected or prepared by a candidate SN:
(1) the source SN may transmit information to the candidate SN to indicate that the another list of CPAC candidate PSCells selected or prepared by the candidate SN is not suitable; for example, the information may be a message or may be indicating information included in a message, and the source SN may transmit such information to one or more candidate SNs separately; or
(2) the source SN may indicate a source MN to transmit information to the candidate SN to indicate that the another list of CPAC candidate PSCells selected or prepared by the candidate SN is not suitable. For example, the source SN may firstly transmit a message to the source MN to inform source MN to indicate one or more candidate SNs that one or more CPAC candidate PSCells are wrongly selected (optionally, ID information of the one or more candidate SNs may be included in the message, the message may be an existing Xn or X2 message, or a new introduced Xn or X2 message), and then, the source MN may transmit a message to the corresponding candidate SN separately to indicate that one or more CPAC candidate PSCells are wrongly selected (the message may be an existing Xn or X2 message, or a new introduced Xn or X2 message). For another instance, the source SN may transmit an indication to the source MN to indicate the source MN to inform one or more candidate SNs that one or more CPAC candidate PSCells are wrongly selected, and then, the source MN may transmit an indication to one or more candidate SNs separately to indicate that one or more CPAC candidate PSCells are wrongly selected (the indication may be included in an existing Xn or X2 message, or in a new introduced Xn or X2 message).

In an embodiment, the cell is a PSCell for recovering the failure, and if the PSCell is included in a list of CPAC candidate PSCells selected or prepared by a candidate SN, the source SN may optimize a set of CPAC execution conditions for the list of CPAC candidate PSCells.

In some embodiments, the source SN may decide the information of the cell, transmit the information of the cell, or receive the information of the cell. In an embodiment, the source SN may obtain the information of the cell by deciding the information of the cell, e.g. in operation 201. Optionally, after deciding the information of the cell, the source SN may transmit the information of the cell, e.g. to the source MN. In another embodiment, if the information of the cell is decided by the source MN, the source SN may receive the information of the cell from the source MN, to obtain the information of the cell, e.g. in operation 201.

In some embodiments, the source SN may receive failure related information associated with the failure, e.g. receive failure related information #1 as described above from the source MN or from a receiving network node (e.g. a third party node different from the source MN or the source SN). In an embodiment, the failure may be an SCG failure, an MCG failure, an RLF, a CHO execution failure, or a CPAC execution failure.

In some embodiments, the failure may occur in a case in which configuration information related to the CHO including target MCG and candidate SCGs for CPC/CPA procedure is configured to a user equipment (UE), but neither a CHO execution nor a CPA/CPC execution is initiated for the UE prior to the failure. In an embodiment, the failure is defined as too late CHO including target MCG and candidate SCGs for CPC/CPA.

In some embodiments, the case in which the failure occurs is any of the following cases, i.e. Cases 1-7:
(1) Case 1: at least one CHO execution condition of a CHO candidate PCell is fulfilled, but a CPA/CPC execution condition of none CPAC candidate PSCell is fulfilled;
(2) Case 2: the at least one CHO execution condition of the CHO candidate PCell is firstly fulfilled, and at least one CPA/CPC execution condition of a CPAC candidate PSCell is secondly fulfilled, but the CPAC candidate PSCell (e.g. the CPAC-execution-condition-fulfilled candidate PSCell) is not associated with the CHO candidate PCell (e.g. the CHO-execution-condition-fulfilled candidate PCell);
(3) Case 3: the at least one CHO execution condition of the CHO candidate PCell is firstly fulfilled, and a leaving condition of the CHO candidate PCell is satisfied when the at least one CPA/CPC execution condition of the CPAC candidate PSCell is secondly fulfilled;
(4) Case 4: the at least one CPAC execution condition of the CPAC candidate PSCell is fulfilled, but a CHO execution condition of none CHO candidate PCell is fulfilled;
(5) Case 5: the at least one CPAC execution condition of the CPAC candidate PSCell is firstly fulfilled, and the at least one CHO execution condition of the CHO candidate PCell is secondly fulfilled, but the CHO candidate PCell (e.g. the CHO-execution-condition-fulfilled candidate PCell) is not associated with the CPAC candidate PSCell (e.g. CPAC-execution-condition-fulfilled CPAC candidate PSCell);
(6) Case 6: the at least one CPAC execution condition of the CPAC candidate PSCell is firstly fulfilled, and a leaving condition of the CPAC candidate PSCell is satisfied when the at least one CHO execution condition of the CHO candidate PCell is secondly fulfilled; and
(7) Case 7: none CHO execution condition is fulfilled, and none CPAC execution condition is fulfilled.

In some embodiments, the failure occurs in any of the following cases, i.e. Cases A-C:
(1) Case A: CHO execution condition(s) and CPAC execution condition(s) are fulfilled, but a CPAC execution fails or an SCG failure occurs shortly after successful completion of the CPAC execution. In Case A, the UE may report failure related information associated with the failure (e.g. failure related information #1 as described above), e.g. via SCG failure information message to target MN when CHO execution is successful.
(2) Case B: CHO execution condition(s) and CPAC execution condition(s) are fulfilled, but a CHO execution fails or an MCG failure occurs shortly after successful completion of the CHO execution. In Case B, the UE may report failure related information associated with the failure (e.g. failure related information #1 as described above), e.g. via MCG failure information message to target SN when CPAC execution is successful.
(3) Case C: CHO execution condition(s) and CPAC execution condition(s) are fulfilled, but the CHO execution fails or the MCG failure occurs shortly after successful completion of the CHO execution, and the CPAC execution fails or the SCG failure occurs shortly after successful completion of the CPAC execution. In Case C, the UE may report failure related information associated with the failure (e.g. failure related information #1 as described above), e.g. via an RLF report.

In some embodiments of the present application, in a CHO including target MCG and candidate SCGs for CPC/CPA procedure (i.e. a CHO with candidate SCGs procedure), CHO execution can be triggered or initiated only when both CHO execution condition(s) and its associated CPA/CPC execution condition(s) are fulfilled, and CPAC (i.e. CPA or CPC) execution can be triggered or initiated only when its associated CHO execution condition(s) is fulfilled. A connection failure (e.g. at least one of an MCG failure, an SCG failure or an RLF) may happen in any of Cases 1-7 described above.

Above Cases 1-7 may be clarified as “too late CHO with candidate SCGs” or “too late CHO including target MCG and candidate SCGs for CPA/CPA” or “too late CHO with CPA/CPC execution”. For example, a failure type definition for a failure occurring in a CHO including target MCG and candidate SCGs for CPC/CPA procedure may be “Too late CHO with candidate SCGs” or “Too late CHO with CPA/CPC execution” or “too late CHO including target MCG and candidate SCGs for CPA/CPA”, in which a CHO including target MCG and candidate SCGs for CPC/CPA procedure is configured to the UE (or the UE receives the configuration for a CHO with candidate SCGs procedure), but neither the CHO execution nor the CPA/CPC execution is initiated or triggered for the UE prior to the connection failure.

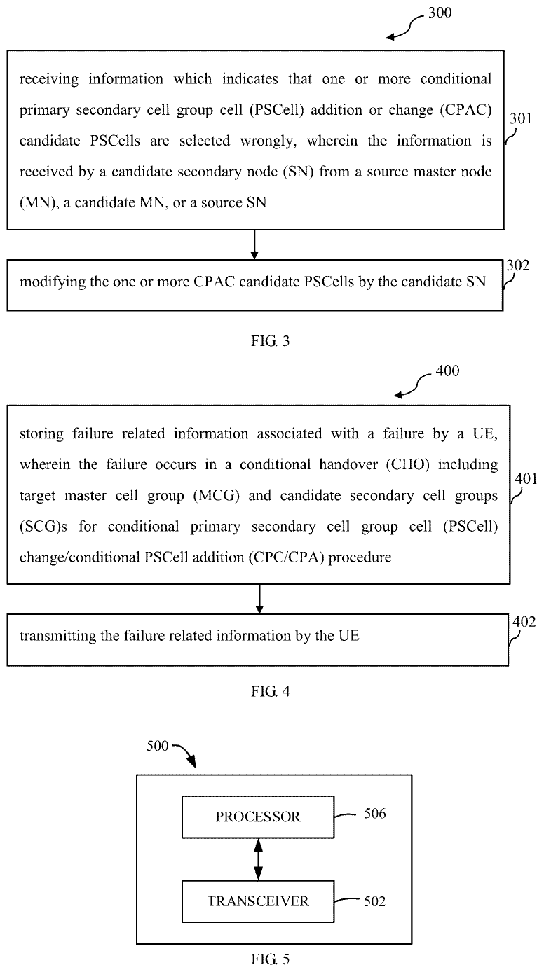

FIG. 3 illustrates an exemplary procedure performed by a candidate SN in accordance with some embodiments of the present application. The exemplary procedure 300 in the embodiments of FIG. 3 may be performed by a candidate (target) SN (a node which manages one or more CPAC candidate PSCells), e.g. SN 103 as shown in FIG. 1. Although described with respect to a candidate (target) SN, it should be understood that other devices may be configured to perform a method similar to that of FIG. 3.

In the exemplary procedure 300 as shown in FIG. 3, a candidate SN may perform at least one of operations 301 and 302. In operation 301, the candidate SN may receive information which indicates that one or more CPAC candidate PSCells are selected wrongly. The information may be received from a source MN, one or more candidate MNs, or a source SN. In operation 302, the candidate SN may modify the one or more CPAC candidate PSCells.

In some embodiments, in operation 301, the information may be received from the source MN, the one or more candidate MNs, or the source SN, if a PSCell for recovering the failure is included in a list of CPAC candidate PSCells suggested or provided by the source MN or by the one or more candidate MNs or by the source SN, but not included in another list of CPAC candidate PSCells selected or prepared by the candidate SN. For example, the information in operation 301 may be a message or may be indicating information included in a message that indicates that one or more CPAC candidate PSCells are selected wrongly.

In some embodiments, the information is received in case that a failure occurs in a CPAC procedure or a CHO including target MCG and candidate SCGs for CPC/CPA procedure (i.e. a CHO with candidate SCGs procedure). For example, the failure may be an SCG failure, an RLF, or a CPAC execution failure.

In some embodiments, the failure occurs in a case in which configuration information related to the CHO including target MCG and candidate SCGs for CPC/CPA procedure is configured to a UE, but neither a CHO execution nor a CPA/CPC execution is initiated for the UE prior to the failure. For example, the failure is defined as “too late CHO including target MCG and candidate SCGs for CPC/CPA” or “too late CHO with CPA/CPC execution” or “too late CHO with candidate SCGs”. In an embodiment, the failure occurs in any one of Cases 1-7 described above in the embodiments of FIG. 2. In another embodiment, the failure occurs in any one of Cases A-C described above in the embodiments of FIG. 2.

In some embodiments, the candidate SN may receive failure related information associated with the failure (e.g. failure related information #1), e.g. from a UE or a source MN or a source SN or at least one candidate MN or a receiving network node (e.g. a third party node different from the source MN or the source SN). In some other embodiments, the candidate SN may transmit failure related information associated with the failure (e.g. failure related information #1), e.g. to a source MN or a source SN or at least one candidate MN. The failure related information may be stored or generated or sent by the UE.

FIG. 4 illustrates an exemplary procedure performed by a UE in accordance with some embodiments of the present application. The exemplary procedure 400 in the embodiments of FIG. 4 may be performed by a UE, e.g. UE 101 as shown in FIG. 1. Although described with respect to a UE, it should be understood that other devices may be configured to perform a method similar to that of FIG. 4.

In the exemplary procedure 400 as shown in FIG. 4, in operation 401, a UE may store failure related information associated with a failure, e.g. failure related information #1 as described above in the embodiments of FIG. 2. The failure may occur in a CHO including target MCG and candidate SCGs for CPC/CPA procedure. In operation 402, the UE may transmit the failure related information, e.g. to the source MN or a (candidate) target MN or a source SN or a (candidate) target SN or a receiving network node.

In some embodiments, the failure may be an MCG failure, an SCG failure, an RLF, a CHO execution failure, or a CPAC execution failure.

In some embodiments, the UE may receive configuration information related to the CHO including target MCG and candidate SCGs for CPC/CPA procedure. The failure may occur in a case in which the configuration information is received but neither a CHO execution nor a CPA/CPC execution is initiated for the UE prior to the failure. For example, the failure is defined as “too late CHO including target MCG and candidate SCGs for CPC/CPA” or “too late CHO with CPA/CPC execution” or “too late CHO with candidate SCGs”. In an embodiment, the failure occurs in any one of Cases 1-7 described above in the embodiments of FIG. 2. In another embodiment, the failure occurs in any one of Cases A-C described above in the embodiments of FIG. 2.

Details described in all other embodiments of the present application are applicable for the embodiments of FIGS. 2-4 performed by a UE, a source MN, a candidate (target) MN, a source SN, or a candidate (target) SN. Moreover, details described in the embodiments of FIGS. 2-4 are applicable for all other embodiments of the present application. It should be appreciated by persons skilled in the art that the sequence of the operations in these exemplary procedures may be changed and some of the operations in these exemplary procedures may be eliminated or modified, without departing from the spirit and scope of the disclosure.

The following texts describe specific Embodiments 1-4 of the exemplary procedures as shown and illustrated in FIGS. 2-4 or the abovementioned exemplary procedures performed by a UE, a source MN, a candidate (target) MN, a source SN, or a candidate (target) SN in a failure case (not limited to the abovementioned Cases 1-7 and Cases A-C).

According to Embodiments 1-4, a UE and network nodes perform following operations. For example, the UE may be UE 101 as shown and illustrated in FIG. 1. A source MN (i.e. S-MN) or a target MN (i.e. T-MN) or a candidate (target) MN may be MN 102 as shown and illustrated in FIG. 1. A source SN (i.e. S-SN) or a target SN (i.e. T-SN) or a candidate (target) SN may be SN 103 as shown and illustrated in FIG. 1.

### Embodiment 1

Embodiment 1 provides a solution of a UE storing or reporting failure related information in a failure case (not limited to the abovementioned Case 1-7 and Case A-C), In Embodiment 1, for a failure case, to enable a network node to understand why a CHO including target MCG and candidate SCGs for CPC/CPA procedure (i.e. a CHO with candidate SCGs procedure) is not successfully performed, or to help the network node know whether or how to modify the configuration for this procedure (e.g. optimize the CHO execution condition(s), CPAC execution condition(s), the list of CHO candidate PCell(s), or the list of CPAC candidate PSCell(s)), a UE may store or report failure related information (e.g. failure related information #1 as described above in the embodiments of FIG. 2). For instance, at least one of the following failure related information may be stored or reported by the UE:
(1) cell information of source PCell, e.g. in Embodiment 1, the cell information may include physical cell identifier (PCI), carrier frequency information (e.g. absolute radio frequency channel number (ARFCN)), and/or, cell global identifier information (CGI-info) (e.g. public land mobile network identity (PLMN-Identity), Cell Identity and TrackingAreaCode);
(2) cell information of failed PCell;
(3) cell information of source PSCell, e.g. the cell information of source PSCell may be stored or reported when the failure case happened in Scenario 2 “CHO with intra-SN CPC” or Scenario 3 “CHO with inter-SN CPC” as described above;
(4) cell information of failed PSCell(s);
(5) the type of the first fulfilled or triggered execution condition (or conditional event) if any, e.g. the first fulfilled or triggered execution condition (or conditional event) is CHO execution condition (or CHO conditional event) or CPAC execution condition (or CPAC conditional event);
(6) the type of the second fulfilled or triggered execution condition (or conditional event) if any, e.g. the second fulfilled or triggered execution condition (or conditional event) is CPAC execution condition (or CPAC conditional event) or CHO execution condition (or CHO conditional event);
(7) information indicating whether one or two CPAC execution conditions (or CPAC conditional events) of a CPAC candidate PSCell is fulfilled or triggered, e.g. if one or more CHO execution conditions (or CHO conditional events) of a CHO candidate PCell is fulfilled or triggered firstly, the information may be an indication. Furthermore, in some embodiments:
   if both the CHO execution condition(s) and the CPAC execution condition(s) are fulfilled, the UE further stores or reports information indicating whether the CPAC-execution-condition-fulfilled candidate PSCell is associated with the CHO-execution-condition-fulfilled candidate PCell, e.g. the information may be an explicit indication, or indicated by cell information of PCell and PSCell explicitly;
   if both the CHO execution condition(s) and the CPAC execution condition(s) are fulfilled, the UE further stores or reports information indicating whether a leaving condition of the CHO-execution-condition-fulfilled candidate PCell is fulfilled (e.g. at the time when the one or two CPAC execution conditions of a CPAC candidate PSCell is fulfilled or triggered);
   if both the CHO execution condition(s) and the CPAC execution condition(s) are fulfilled, the UE further stores or reports the time duration between the two fulfilled or triggered execution conditions or conditional events, e.g. the time elapsed since one or two CHO execution conditions of a CHO candidate PCell is fulfilled or triggered until one or two CPAC execution conditions of a CPAC candidate PSCell is fulfilled or triggered (for the case that if the CHO execution condition(s) and CPAC execution condition(s) are associated, or if CPAC-execution-condition-fulfilled candidate PSCell is associated with the CHO-execution-condition-fulfilled candidate PCell).
(8) information indicating whether one or two CHO execution conditions (or CHO conditional events) of a CHO candidate PCell is fulfilled or triggered, e.g. if one or two CPAC execution conditions (or CPAC conditional events) of a CPAC candidate PSCell is fulfilled or triggered first, the information may be an indication. Furthermore, in some embodiments:
   if both the CHO execution condition(s) and the CPAC execution condition(s) are fulfilled, the UE further stores or reports information indicating whether CHO-execution-condition-fulfilled candidate PCell is associated with the CPAC-execution-condition-fulfilled candidate PSCell, e.g. the information may be an explicit indication, or indicated by cell information of PCell and PSCell explicitly;
   if both the CHO execution condition(s) and the CPAC execution condition(s) are fulfilled, the UE further stores or reports information indicating whether a leaving condition of the CPAC-execution-condition-fulfilled candidate PSCell is fulfilled (e.g. at the time when the one or two CHO execution conditions of a CHO candidate PCell is fulfilled or triggered);
   if both the CHO execution condition(s) and the CPAC execution condition(s) are fulfilled, the UE further stores or reports the time duration between the two fulfilled or triggered execution conditions or conditional events, e.g. the time elapsed since one or two CPAC execution conditions of a CPAC candidate PSCell is fulfilled or triggered until one or two CHO execution conditions of a CHO candidate PCell is fulfilled or triggered (for the case that if the CHO execution condition(s) and CPAC execution condition(s) are associated, or if CHO-execution-condition-fulfilled candidate PCell is associated with the CPAC-execution-condition-fulfilled candidate PSCell).

In Embodiment 1, at least one of the above failure related information may be reported by the UE via an MCG failure information message or an SCG failure information message or an RLF report.

### Embodiment 2

Embodiment 2 provides a solution of how a network node performs MRO analysis for a CHO including target MCG and candidate SCGs for CPC/CPA procedure (i.e. a CHO with candidate SCGs procedure). In particular, Embodiment includes specific Embodiments 2-1, 2-2, and 2-3 as follows in different cases.

### Embodiment 2-1

In Embodiment 2-1, for a CHO including target MCG and candidate SCGs for CPC procedure, when an MCG failure or an RLF or a CHO execution failure happens, a UE may send failure related information to S-SN, e.g. via an MCG failure information message. The detailed failure related information or information included in the MCG failure information message can refer to Embodiment 1 (e.g. failure related information #1 as described above in the embodiments of FIG. 2). S-SN may transfer the failure related information to S-MN.

In Embodiment 2-1, for a CHO including target MCG and candidate SCGs for CPA procedure, when an MCG failure or an RLF or a CHO execution failure happens, the UE may send failure related information to a receiving node (which is a third party node different from S-MN), e.g. via an RLF report, the detailed failure related information or information included in the RLF report can refer to Embodiment 1 (e.g. failure related information #1 as described above in the embodiments of FIG. 2). The receiving node may transfer the failure related information to S-MN. Or, the receiving node may transfer the failure related information to S-SN. Or, the receiving node may transfer the failure related information to at least one candidate (target) MN. Or, the receiving node may transfer the failure related information to at least one candidate (target) SN.

In Embodiment 2-1, when the failure occurs, or when S-MN receives the failure related information, S-MN may select a PCell for recovering the failure (e.g. S-MN may select a PCell for fast MCG failure recovery), and S-MN may perform root cause analysis, e.g. S-MN may perform the following operations:
(1) If the selected PCell is not included in the CHO candidate PCell(s) suggested or informed or provided by S-MN to candidate (target) MN(s) which manages CHO candidate PCell(s), S-MN knows that the CHO candidate PCell(s) suggested or informed or provided by S-MN are unsuitable, S-MN may modify the list of CHO candidate PCell(s) for MRO purpose.
(2) If the selected PCell is included in the CHO candidate PCell(s) suggested or informed or provided by S-MN to candidate (target) MN(s), but not included in the CHO candidate PCell(s) selected or prepared by candidate (target) MN(s), S-MN may understand that wrong CHO candidate PCell(s) is selected or prepared by the candidate (target) MN(s). If so, S-MN may inform candidate (target) MN(s) that wrong CHO candidate PCell(s) is selected or prepared separately, e.g. via a message or an indication. The candidate (target) MN(s) may modify the CHO candidate PCell(s) that selected or prepared for the CHO including target MCG and candidate SCGs for CPC procedure.
(3) If the selected PCell is included in the CHO candidate PCell(s) selected or prepared by candidate (target) MN(s), S-MN may know that it sets unsuitable CHO execution condition(s) for the CHO candidate PCell(s) configured to the UE or for the CHO candidate PCell(s) selected or prepared by candidate (target) MN(s). S-MN may optimize CHO execution condition(s) for these CHO candidate PCell(s).

### Embodiment 2-2

In Embodiment 2-2, for a CHO including target MCG and candidate SCGs for CPC/CPA procedure, when SCG failure or an RLF or CPAC execution failure happens, the UE may send failure related information to source MN (S-MN), e.g. via the SCG failure information message, the detailed failure related information or information included in the SCG failure information message can refer to Embodiment 1 (e.g. failure related information #1 as described above in the embodiments of FIG. 2).

### Embodiment 2-2-1

Embodiment 2-2-1 assume that one or more candidate (target) MNs suggest or inform or provide CPAC candidate PSCell(s), and CPAC execution condition(s) of CPAC candidate PSCell(s) is decided or generated by the one or more candidate (target) MNs. A candidate (target) SN is a node which manages one or more CPAC candidate PSCell(s). A candidate (target) MN is a node which manages one or more CHO candidate PCell(s).

In Embodiment 2-2-1, when the failure occurs, or when S-MN receives the failure related information, S-MN may select a PSCell, e.g. S-MN may select a suitable PSCell for SCG reconfiguration; if S-MN selects the PSCell, S-MN may send the cell information of the selected PSCell to one or more candidate (target) MNs; or, one candidate (target) MN may select a PSCell for recovering the failure, e.g. the candidate (target) MN may select a suitable PSCell for SCG reconfiguration; if candidate (target) MN selects the PSCell, candidate (target) MN may send the cell information of the selected PSCell to S-MN, and S-MN may send the PSCell information to the UE for SCG reconfiguration.

In Embodiment 2-2-1, S-MN may perform initial analysis, and/or, S-MN may send the failure related information to the one or more candidate (target) MNs separately, e.g. via the existing X2/Xn message or a new introduced X2/Xn message. The one or more candidate (target) MNs may send the failure related information to the one or more candidate (target) SNs separately, e.g. via the existing X2/Xn message or a new introduced X2/Xn message. In Embodiment 2-2-1, S-MN may send the failure related information to the source SN, e.g. via the existing X2/Xn message or a new introduced X2/Xn message.

In Embodiment 2-2-1, any one candidate (target) MN within the one or more candidate (target) MNs may perform root cause analysis, e.g. the candidate (target) MN may perform the following operations:
(1) If the selected PSCell is not included in the CPAC candidate PSCell(s) suggested or informed or provided by the candidate (target) MN to one or more candidate (target) SNs, the candidate (target) MN knows that the CPAC candidate PSCell(s) suggested or informed or provided by itself are unsuitable. Then, the candidate (target) MN may modify the list of CPAC candidate PSCell(s) for MRO purpose.
(2) If the selected PSCell is included in the CPAC candidate PSCell(s) suggested or informed or provided by the candidate (target) MN to one or more candidate (target) SNs, but not included in the CPAC candidate PSCell(s) selected or prepared by one or more candidate (target) SNs, the candidate (target) MN knows that the list of CPAC candidate PSCell(s) is wrongly selected or prepared by the candidate (target) SN(s). If so, the candidate (target) MN may inform the one or more candidate (target) SNs separately that the list of CPAC candidate PSCell(s) is wrongly selected or prepared, e.g. via a message or an indication. Then, the one or more candidate (target) SNs may separately modify the CPAC candidate PSCell(s) selected or prepared for the CHO including target MCG and candidate SCGs for CPC/CPA procedure.
(3) If the selected PSCell is included in the CPAC candidate PSCell(s) selected or prepared by one or more candidate (target) SNs, the candidate (target) MN knows that it sets unsuitable CPAC execution condition(s) for the CPAC candidate PSCell(s) configured to the UE (or for the CPAC candidate PSCell(s) selected or prepared by the one or more candidate (target) SN(s)). Then, the candidate (target) MN may optimize CPAC execution condition(s) for these CPAC candidate PSCell(s).

### Embodiment 2-2-2

Embodiment 2-2-2 assume that S-MN suggests or informs or provides CPAC candidate PSCell(s), and CPAC execution condition(s) of CPAC candidate PSCell(s) is decided or generated by a candidate (target) MN.

In Embodiment 2-2-2, when the failure occurs, or when S-MN receives the failure related information, S-MN may select a PSCell for recovering the failure (e.g. S-MN may select a suitable PSCell for SCG reconfiguration); if S-MN selects the PSCell, S-MN may send the cell information of the selected PSCell to one or more candidate (target) MNs; or, a candidate (target) MN may select a PSCell for recovering the failure (e.g. the candidate (target) MN may select a suitable PSCell for SCG reconfiguration); if the candidate (target) MN selects the PSCell, the candidate (target) MN may send the cell information of the selected PSCell to S-MN, and S-MN may send the PSCell information to the UE for SCG reconfiguration.

In Embodiment 2-2-2, S-MN may send the failure related information to the one or more candidate (target) MNs separately, e.g. via the existing X2/Xn message or a new introduced X2/Xn message. The one or more candidate (target) MNs may send the failure related information to the one or more candidate (target) SNs separately, e.g. via the existing X2/Xn message or a new introduced X2/Xn message.

In Embodiment 2-2-2, S-MN may send the failure related information to the source SN, e.g. via the existing X2/Xn message or a new introduced X2/Xn message.

In Embodiment 2-2-2, S-MN may perform root cause analysis, e.g. S-MN may perform the following operations:
(1) If the selected PSCell is not included in the CPAC candidate PSCell(s) suggested or provided by S-MN, S-MN knows that the CPAC candidate PSCell(s) suggested or provided by S-MN are unsuitable. Then, S-MN may modify the list of CPAC candidate PSCell(s) for MRO purpose.
(2) If the selected PSCell is included in the CPAC candidate PSCell(s) suggested or provided by S-MN, but not included in the CPAC candidate PSCell(s) selected or prepared by one or more candidate (target) SNs, S-MN knows that the one or more wrong CPAC candidate PSCells are selected or prepared by the one or more candidate (target) SNs. If so, S-MN may separately inform one or more candidate (target) SNs that the one or more wrong CPAC candidate PSCells are selected or prepared directly (e.g. via a message or an indication), or indirectly via the one or more candidate (target) MNs (i.e. S-MN may indicate the one or more candidate (target) MNs to inform one or more candidate (target) SNs that the one or more wrong CPAC candidate PSCells are selected or prepared (e.g. via a message or an indication); and optionally, ID information of the one or more candidate (target) SNs may be informed by the S-MN to the one or more candidate (target) MNs. Then, any one candidate (target) MN within the one or more candidate (target) MNs may separately inform one or more candidate (target) SNs that the one or more wrong CPAC candidate PSCells are selected or prepared (e.g. via a message or an indication, correspondingly based on the ID information of the one or more candidate (target) SNs)). The one or more candidate (target) SNs may separately modify the CPAC candidate PSCell(s) that selected or prepared for the CHO including target MCG and candidate SCGs for CPC/CPA procedure.
(3) If the selected PSCell is included in the CPAC candidate PSCell(s) selected or prepared by one or more candidate (target) SN(s), S-MN knows that one or more candidate (target) MNs sets unsuitable CPAC execution condition(s) for the CPAC candidate PSCell(s) configured to the UE (or for the CPAC candidate PSCell(s) selected or prepared by the one or more candidate (target) SN(s)). S-MN may separately inform the one or more candidate (target) MNs that CPAC execution condition(s) is set improperly (e.g. via a message or an indication). Then, the candidate (target) MN(s) may optimize CPAC execution condition(s) for these CPAC candidate PSCell(s) separately.

### Embodiment 2-2-3

Embodiment 2-2-3 assume that S-MN suggests or informs or provides CPAC candidate PSCell(s), and CPAC execution condition(s) of CPAC candidate PSCell(s) is decided or generated by S-MN.

In Embodiment 2-2-3, when the failure occurs, or when S-MN receives the failure related information, S-MN may select a PSCell for recovering the failure (e.g. S-MN may select a suitable PSCell for SCG reconfiguration); if S-MN selects the PSCell, S-MN may send the cell information of the selected PSCell to one or more candidate (target) MNs; or, a candidate (target) MN may select a PSCell for recovering the failure (e.g. the candidate (target) MN may select a suitable PSCell for SCG reconfiguration); if candidate (target) MN selects the PSCell, candidate (target) MN may send the cell information of the selected PSCell to S-MN, and S-MN may send the PSCell information to the UE for SCG reconfiguration.

In Embodiment 2-2-3, S-MN may send the failure related information to the one or more candidate (target) MNs separately, e.g. via the existing X2/Xn message or a new introduced X2/Xn message. The one or more candidate (target) MNs may send the failure related information to the one or more candidate (target) SNs separately, e.g. via the existing X2/Xn message or a new introduced X2/Xn message. In Embodiment 2-2-3, S-MN may send the failure related information to the source SN, e.g. via the existing X2/Xn message or a new introduced X2/Xn message.

In Embodiment 2-2-3, S-MN may perform root cause analysis, e.g. the S-MN may perform the following operations:
(1) If the selected PSCell is not included in the CPAC candidate PSCell(s) suggested or provided by S-MN, S-MN knows that the CPAC candidate PSCell(s) suggested or provided by S-MN are unsuitable, and S-MN may modify the list of CPAC candidate PSCell(s) for MRO purpose.
(2) If the selected PSCell is included in the CPAC candidate PSCell(s) suggested or provided by S-MN, but not included in the CPAC candidate PSCell(s) selected or prepared by one or more candidate (target) SNs, S-MN knows that the list of CPAC candidate PSCell(s) is wrongly selected or prepared by the one or more candidate (target) SN(s). If so, S-MN may inform one or more candidate (target) SNs that the list of CPAC candidate PSCell(s) is wrongly selected or prepared directly (e.g. via a message or an indication), or indirectly via one or more candidate (target) MNs (i.e. S-MN may separately indicate one or more candidate (target) MNs to inform one or more candidate (target) SNs that the list of CPAC candidate PSCell(s) is wrongly selected or prepared (e.g. via a message or an indication); and optionally, ID information of the one or more candidate (target) SNs may be informed by the S-MN to the one or more candidate (target) MNs. Then, any one candidate (target) MN within the one or more candidate (target) MNs may separately inform one or more candidate (target) SNs that the list of CPAC candidate PSCell(s) is wrongly selected or prepared (e.g. via a message or an indication, correspondingly based on the ID information of the one or more candidate (target) SNs). The one or more candidate (target) SNs may separately modify the CPAC candidate PSCell(s) that selected or prepared for the CHO including target MCG and candidate SCGs for CPC/CPA procedure.
(3) If the suitable PSCell is included in the CPAC candidate PSCell(s) selected or prepared by one or more candidate (target) SN(s), S-MN knows that it sets unsuitable CPAC execution condition(s) for the CPAC candidate PSCell(s) configured to the UE (or for the CPAC candidate PSCell(s) selected or prepared by the one or more candidate (target) SN(s). Then, S-MN may optimize CPAC execution condition(s) for these CPAC candidate PSCell(s).

### Embodiment 2-2-4

Embodiment 2-2-4 assume that one or more candidate (target) MN(s)s suggest or inform or provide CPAC candidate PSCell(s), and CPAC execution condition(s) of CPAC candidate PSCell(s) is decided or generated by S-MN.

In Embodiment 2-2-4, when the failure occurs, or when S-MN receives the failure related information, S-MN may select a PSCell (e.g. S-MN may select a suitable PSCell for SCG reconfiguration); if S-MN selects the PSCell, S-MN may send the cell information of the selected PSCell to one or more candidate (target) MNs; or, a candidate (target) MN may select a PSCell for recovering the failure (e.g. the candidate (target) MN may select a suitable PSCell for SCG reconfiguration); if candidate (target) MN selects the PSCell, candidate (target) MN may send the cell information of the selected PSCell to S-MN, and S-MN may send the PSCell information to the UE for SCG reconfiguration.

In Embodiment 2-2-4, S-MN may perform initial analysis, and/or, S-MN may send the failure related information to the one or more candidate (target) MNs, e.g. via the existing X2/Xn message or a new introduced X2/Xn message. The one or more candidate (target) MNs may send the failure related information to the one or more candidate (target) SNs separately, e.g. via the existing X2/Xn message or a new introduced X2/Xn message. In Embodiment 2-2-4, S-MN may send the failure related information to the source SN, e.g. via the existing X2/Xn message or a new introduced X2/Xn message.

In Embodiment 2-2-4, any one candidate (target) MN within the one or more candidate (target) MNs may perform root cause analysis, e.g. the candidate (target) MN may perform the following operations:
(1) If the selected PSCell is not included in the CPAC candidate PSCell(s) suggested or informed or provided by candidate (target) MN to one or more candidate (target) SNs, the candidate (target) MN knows that the CPAC candidate PSCell(s) suggested or informed or provided by the candidate (target) MN are unsuitable. Then, the candidate (target) MN may modify the list of CPAC candidate PSCell(s) for MRO purpose.
(2) If the selected PSCell is included in the CPAC candidate PSCell(s) suggested or informed or provided by the candidate (target) MN to one or more candidate (target) SNs, but not included in the CPAC candidate PSCell(s) selected or prepared by one or more candidate (target) SNs, the candidate (target) MN knows that the one or more wrong CPAC candidate PSCells are selected or prepared by the candidate (target) SN(s). If so, the candidate (target) MN may inform the one or more candidate (target) SNs separately that the one or more wrong CPAC candidate PSCells are selected or prepared, e.g. via a message or an indication. Then, the one or more candidate (target) SNs may separately modify the CPAC candidate PSCell(s) that selected or prepared for the CHO with candidate SCGs procedure;
(3) if the selected PSCell is included in the CPAC candidate PSCell(s) selected or prepared by one or more candidate (target) SNs, the candidate (target) MN knows that S-MN sets unsuitable CPAC execution condition(s) for the CPAC candidate PSCell(s) configured to the UE (or for the CPAC candidate PSCell(s) selected or prepared by the one or more candidate (target) SNs). The candidate (target) MN may inform S-MN that CPAC execution condition(s) is set improperly, e.g. via a message or an indication. Then, S-MN may optimize CPAC execution condition(s) for these CPAC candidate PSCell(s).

### Embodiment 2-3

In Embodiment 2-3, for a CHO including target MCG and candidate SCGs for CPC/CPA procedure, when both MCG failure and SCG failure happen, a UE may send failure related information to a network node (e.g. a node different from source MN or source SN), e.g. via an RLF report. The detailed failure related information or information included in the RLF report can refer to Embodiment 1 (e.g. failure related information #1 as described above in the embodiments of FIG. 2).

In Embodiment 2-3, the network node which receives the failure related information or the RLF report may forward the failure related information or the RLF report to the S-MN. S-MN may forward the failure related information or the RLF report to S-SN or one or more candidate (target) MNs. The one or more candidate (target) MNs may transfer the failure related information or the RLF report to one or more candidate (target) SNs.

### Embodiment 3

Embodiment 3 provides a solution of MRO analysis for a CHO procedure. In a CHO procedure, when an RLF occurs before CHO execution condition is satisfied, or when CHO execution failure happens, a receiving node (i.e. a node which receives an RLF report from a UE) sends the RLF report to a source node, via a failure indication message. In a CHO procedure, when an RLF occurs shortly after a successful CHO execution from a source cell to a target cell, a receiving node (a node which receives an RLF report from a UE) sends the RLF report to the target node, via a failure indication message, and then, the target node may send the RLF report to the source node, via a handover (HO) report message.

In Embodiment 3, when the failure occurs, the UE may select a cell for recovering the failure (e.g. the UE may select a cell for CHO recovery), and the cell may be presented by the choCellId information element (IE) in 3GPP standard document TS38.331 which is used to indicate the candidate (target) cell for conditional handover included in condRRCReconfig IE that the UE selected for CHO based recovery while timer T311 is running, or if the cell selected for failure recovery/re-establishment attempt is not a candidate (target) cell for conditional reconfiguration, the cell may be presented by reestablishmentCellId IE in 3GPP standard document TS38.331 which is used to indicate the cell in which the failure recovery/re-establishment attempt was made after the failure. Cell information of the cell for recovering the failure may be included in the RLF report. In Embodiment 3, a source node may perform root cause analysis, e.g. the source node may perform the following operations:
(1) If the cell for recovering the failure is not contained in the CHO candidate PCell(s) suggested or provided by a source node, the source node knows the CHO candidate PCell(s) suggested or provided by the source node are unsuitable. Then, the source node may modify the list of CHO candidate PCell(s) for MRO purpose.
(2) If the cell for recovering the failure is contained in the CHO candidate PCell(s) suggested or provided by the source node, but not contained in the CHO candidate PCell(s) selected or prepared by one or more candidate (target) nodes, the source node knows that the list of CHO candidate PCell(s) is wrongly selected or prepared by the one or more candidate (target) nodes. If so, the source node informs one or more candidate (target) nodes separately that the one or more wrong CHO candidate PCells are selected or prepared, e.g. via a message or an indication. Then, the one or more candidate (target) nodes may modify the selected or prepared CHO candidate PCell(s).
(3) If the cell for recovering the failure is contained in the CHO candidate PCell(s) selected or prepared by one or more candidate (target) nodes, the source node knows that it sets unsuitable CHO execution condition(s) for the candidate PCell(s) configured to the UE (or the CHO candidate PCell(s) selected or prepared by candidate (target) node(s)). Then, the source node may optimize CHO execution condition(s) for these CHO candidate PCell(s).

### Embodiment 4

Embodiment 4 provides a solution of MRO analysis for a CPA procedure or a CPC procedure or a CPAC procedure. In a CPA procedure, when CPA execution fails, or when an SCG failure occurs shortly after a successful CPA execution, a UE may send the SCG failure information message to an MN. In a CPC procedure, when an SCG failure occurs before CPC execution condition is satisfied, or when CPC execution fails, or when an SCG failure occurs shortly after a successful CPC execution from a source PSCell to a target PSCell, a UE may send the SCG failure information message to an MN.

In Embodiment 4, for a CPA procedure or an MN initiated CPC procedure, when the failure occurs, or when an MN receives the failure related information in an SCG failure information message, the MN may select a PSCell for recovering the failure, e.g. MN may select a suitable PSCell for SCG reconfiguration. The MN may perform root cause analysis, e.g. the MN may perform the following operations:
(1) if the selected PSCell is not included in the CPAC candidate PSCell(s) suggested or informed by the MN to one or more candidate (target) SNs, the MN knows the CPAC candidate PSCell(s) suggested or informed by the MN are unsuitable, the MN may modify the list of CPAC candidate PSCell(s);
(2) if the selected PSCell is included in the CPAC candidate PSCell(s) suggested or informed by the MN, but not included in the CPAC candidate PSCell(s) selected or prepared by one or more candidate (target) SNs, the MN knows that the list of CPAC candidate PSCell(s) is wrongly selected or prepared by the one or more candidate (target) SNs; if so, the MN may separately inform one or more candidate (target) SNs that the list of CPAC candidate PSCell(s) is wrongly selected or prepared, e.g. via a message or an indication, the one or more candidate (target) SNs may separately modify the selected or prepared CPAC candidate PSCell(s);
(3) if the selected PSCell is included in the CPAC candidate PSCell(s) selected or prepared by one or more candidate (target) SNs, the MN knows it sets unsuitable CPAC execution condition(s) for the candidate PSCell(s) configured to the UE (or for the CPAC candidate PSCell(s) selected or prepared by the one or more candidate (target) SNs), and the MN may optimize CPAC execution condition(s) for these candidate PSCell(s);

In Embodiment 4, for an SN initiated CPC procedure, in an example, when the failure occurs, or when an MN receives the failure related information in an SCG failure information message, the MN may select a PSCell for recovering the failure (e.g. MN may select a suitable PSCell for SCG reconfiguration), and then, the MN may send the cell information of the selected PSCell to the source SN; in another example, when the failure occurs, or when a source SN receives the failure related information, the source SN may select a PSCell for recovering the failure (e.g. the source SN may select a suitable PSCell for SCG reconfiguration), and then, the source SN may send the cell information of the selected PSCell to the MN. In Embodiment 4, the MN may perform initial analysis and transfer SCG failure information to S-SN, and S-SN may perform root cause analysis, e.g. S-SN may perform the following operations:
(1) If the selected PSCell is not included in the CPAC candidate PSCell(s) suggested or provided by S-SN, S-SN knows that the CPAC candidate PSCell(s) suggested or provided by S-SN are unsuitable. Then, S-SN may modify the list of CPAC candidate PSCell(s).
(2) If the selected PSCell is included in the CPAC candidate PSCell(s) suggested or provided by S-SN, but not included in the CPAC candidate PSCell(s) selected or prepared by one or more candidate (target) SNs, S-SN knows that the list of CPAC candidate PSCell(s) is wrongly selected or prepared by the one or more candidate (target) SNs. If so, S-SN may separately inform one or more candidate (target) SNs that the list of CPAC candidate PSCell(s) is wrongly selected or prepared directly, e.g. via a message or an indication, or indirectly via the MN (i.e. S-SN may indicate the MN to inform one or more candidate (target) SNs that the list of CPAC candidate PSCell(s) is wrongly selected or prepared (e.g. via a message or an indication), and optionally, ID information of the one or more candidate (target) SNs may be informed by the S-SN to the MN. Then, the MN may separately inform one or more candidate (target) SNs that the list of CPAC candidate PSCell(s) is wrongly selected or prepared (e.g. via a message or an indication, correspondingly based on the ID information of the one or more candidate (target) SNs). The one or more candidate (target) SNs may separately modify the selected or prepared CPAC candidate PSCell(s).
(3) If the selected PSCell is included in the CPAC candidate PSCell(s) selected or prepared by one or more candidate (target) SNs, S-SN knows that it sets unsuitable CPAC execution condition(s) for the candidate PSCell(s) configured to the UE (or for the CPAC candidate PSCell(s) selected or prepared by the one or more candidate (target) SNs), S-SN may optimize CPAC execution condition(s) for these candidate PSCell(s).

FIG. 5 illustrates a block diagram of an exemplary apparatus 500 in accordance with some embodiments of the present disclosure. As shown in FIG. 5, the apparatus 500 may include at least one processor 506 and at least one transceiver 502 coupled to the processor 506.

Although in this figure, elements such as the at least one transceiver 502 and processor 506 are described in the singular, the plural is contemplated unless a limitation to the singular is explicitly stated. In some embodiments of the present application, the transceiver 502 may be divided into two devices, such as a receiving circuitry and a transmitting circuitry. In some embodiments of the present application, the apparatus 500 may further include an input device, a memory, and/or other components.

In some embodiments of the present application, the apparatus 500 may be a UE, a source MN, a candidate MN, a source SN, or a candidate SN. The transceiver 502 and the processor 506 may interact with each other so as to perform the operations with respect to the UE, the candidate MN, the source MN, the candidate SN, or the source SN described above, for example, in any of FIGS. 1-4.

In some embodiments of the present application, the apparatus 500 may further include at least one non-transitory computer-readable medium. For example, in some embodiments of the present disclosure, the non-transitory computer-readable medium may have stored thereon computer-executable instructions to cause the processor 506 to implement the method with respect to the UEs as described above. For example, the computer-executable instructions, when executed, cause the processor 506 interacting with transceiver 502 to perform the operations with respect to the UE, the candidate MN, the source MN, the candidate SN, or the source SN described in FIGS. 1-4.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A network node, comprising:
at least one memory; and
at least one processor coupled with the at least one memory and configured to cause the network node to:
obtain information of a cell for recovering a failure that occurs as at least one of a conditional handover (CHO) procedure, a conditional primary secondary cell group cell (PSCell) addition or change (CPAC) procedure, or a CHO including target master cell group (MCG) and candidate secondary cell groups (SCG)s for a conditional PSCell change/conditional PSCell addition (CPC/CPA) procedure; and
perform analysis for the failure.

2. The network node of claim 1, wherein the network node is a source master node (MN), the at least one processor is configured to cause the source MN to at least one of:
modify a list of CPAC candidate PSCells;
transmit first information to at least one candidate SN to indicate that one or more CPAC candidate PSCells are wrongly selected;
indicate one or more candidate MNs to transmit the first information to the at least one candidate SN;
optimize a set of CPAC execution conditions; or
transmit second information to the one or more candidate MNs to indicate that the set of CPAC execution conditions are configured improperly.

3. The network node of claim 1, wherein the network node is a source master node (MN), the at least one processor is configured to cause the source MN to at least one of:
modify a list of CHO candidate PCells;
transmit first information to at least one candidate MN to indicate that one or more CHO candidate PCells are wrongly selected; or
optimize a set of CHO execution conditions.

4. The network node of claim 3, wherein the at least one processor is configured to cause the source MN to:
decide the information of the cell;
transmit the information of the cell; or
receive the information of the cell.

5. The network node of claim 3, wherein the at least one processor is configured to cause the source MN to:
transmit failure related information associated with the failure; or
receive the failure related information.

6. The network node of claim 1, wherein the network node is a candidate master node (MN), the at least one processor is configured to cause the candidate MN to at least one of:
modify a list of CPAC candidate PSCells;
transmit first information to at least one candidate SN to indicate that one or more CPAC candidate PSCells are wrongly selected;
optimize a set of CPAC execution conditions; or
transmit second information to a source MN to indicate that the set of CPAC execution conditions are configured improperly.

7. The network node of claim 1, wherein the network node is a candidate master node (MN), the at least one processor is configured to cause the candidate MN to at least one of:
receive first information from a source MN which indicates that at least one CHO candidate PCell is wrongly selected; or
modify one or more CHO candidate PCells selected by the candidate MN.

8. The network node of claim 7, wherein the at least one processor is configured to cause the candidate MN to:
decide the information of the cell;
transmit the information of the cell; or
receive the information of the cell.

9. The network node of claim 7, wherein the at least one processor is configured to cause the candidate MN to receive failure related information associated with the failure.

10. The network node of claim 1, wherein the network node is a source secondary node (SN), the at least one processor is configured to cause the source SN to at least one of:
modify a list of CPAC candidate PSCells;
transmit first information to at least one candidate SN to indicate that one or more CPAC candidate PSCells are wrongly selected;
indicate a source MN to transmit the first information to the at least one candidate SN; or
optimize a set of CPAC execution conditions.

11. The network node of claim 10, wherein the at least one processor is configured to cause the source SN to:
decide the information of the cell;
transmit the information of the cell; or
receive the information of the cell.

12. The network node of claim 10, wherein the at least one processor is configured to cause the source SN to receive failure related information associated with the failure.

13. The network node of claim 12, wherein the failure related information includes at least one of:
a type of a first fulfilled execution condition;
a type of a second fulfilled execution condition;
second information indicating whether a CPAC execution condition of a CPAC candidate PSCell is fulfilled;
third information indicating whether a CHO execution condition of a CHO candidate PCell is fulfilled;
fourth information indicating whether a CPAC-execution-condition-fulfilled candidate PSCell is associated with a CHO-execution-condition-fulfilled candidate PCell;
fifth information indicating whether a leaving condition of the CHO-execution-condition-fulfilled candidate PCell is fulfilled;
sixth information indicating whether a leaving condition of the CPAC-execution-condition-fulfilled candidate PSCell is fulfilled;
time elapsed since the CHO execution condition is fulfilled until the CPAC execution condition is fulfilled; or
time elapsed since the CPAC execution condition is fulfilled until the CHO execution condition is fulfilled.

14. A candidate secondary node (SN), comprising:
at least one memory; and
at least one processor coupled with the at least one memory and configured to cause the candidate SN to:
receive information which indicates that one or more conditional primary secondary cell group cell (PSCell) addition or change (CPAC) candidate PSCells are selected wrongly, wherein the information is received from a source master node (MN), a candidate MN, or a source SN; or
modify the one or more CPAC candidate PSCells.

15. A user equipment (UE), comprising:
at least one memory; and
at least one processor coupled with the at least one memory and configured to cause the UE to:
store failure related information associated with a failure that occurs in a conditional handover (CHO) including target master cell group (MCG) and candidate secondary cell groups (SCGs) for a conditional primary secondary cell group cell (PSCell) change/conditional PSCell addition (CPC/CPA) procedure; and
transmit the failure related information.

16. A method performed by a network node, the method comprising:
obtaining information of a cell for recovering a failure that occurs as at least one of a conditional handover (CHO) procedure, a conditional primary secondary cell group cell (PSCell) addition or change (CPAC) procedure, or a CHO including target master cell group (MCG) and candidate secondary cell groups (SCG)s for a conditional PSCell change/conditional PSCell addition (CPC/CPA) procedure; and
performing analysis for the failure.

17. The method of claim 16, wherein the network node is a source master node (MN), the method further comprising at least one of:
modifying a list of CPAC candidate PSCells;
transmitting first information to at least one candidate SN to indicate that one or more CPAC candidate PSCells are wrongly selected;
indicating one or more candidate MNs to transmit the first information to the at least one candidate SN;
optimizing a set of CPAC execution conditions; or
transmitting second information to the one or more candidate MNs to indicate that the set of CPAC execution conditions are configured improperly.

18. The method of claim 16, wherein the network node is a source master node (MN), the method further comprising at least one of:
modifying a list of CHO candidate PCells;
transmitting first information to at least one candidate MN to indicate that one or more CHO candidate PCells are wrongly selected; or
optimizing a set of CHO execution conditions.

19. The method of claim 16, wherein the network node is a candidate master node (MN), the method further comprising at least one of:
modifying a list of CPAC candidate PSCells;
transmitting first information to at least one candidate SN to indicate that one or more CPAC candidate PSCells are wrongly selected;
optimizing a set of CPAC execution conditions; or
transmitting second information to a source MN to indicate that the set of CPAC execution conditions are configured improperly.

20. The method of claim 16, the network node is a candidate master node (MN), the method further comprising at least one of:
receiving first information from a source MN which indicates that at least one CHO candidate PCell is wrongly selected; or
modifying one or more CHO candidate PCells selected by the candidate MN.
